(19) United States
(12) Patent Application Publication
(10) Pub. No.: US 2008/0188339 A1
(43) Pub. Date: Aug. 7, 2008

(54) Multi-Group Transmission

(76) Inventors: Josef Bader, Friedrichshafen (DE); Stefan Renner, Ludwigshafen (DE); Reiner Keller, Bodmann-Ludwigshafen (DE)

Correspondence Address: DAVIS BUJOLD & Daniels, P.L.L.C., 112 PLEASANT STREET, CONCORD, NH, 03301, US

(21) Appl. No.: 11/913,715

(22) PCT Filed: Apr. 18, 2006
(86) PCT No.: PCT/EP06/03509

§ 371 Date: Nov. 6, 2007

(30) Foreign Application Priority Data
May 11, 2005 (DE) 10 2005 021 761.3

(51) Int. Cl. F16H 57/02

(52) U.S. Cl. 475/149

(57) ABSTRACT

A multi-group transmission is proposed, said transmission comprising a gearbox actuator, in which the working cylinder of the activating devices of the gearbox actuator, the required air channels (2), and the clutch actuator (4) are integrated into the gearbox housing (3).

This application is a national stage completion of PCT/EP2006/003509 filed Apr. 18, 2006, which claims priority from German Application Serial No. 10 2005 021 761.3 filed May 11, 2005.

### FIELD OF THE INVENTION

The invention relates to a multi-group transmission.

### BACKGROUND OF THE INVENTION

Transmissions for commercial vehicles normally feature twelve, sixteen, or more gears. These types of multi-speed gearboxes are usually configured as multi-group transmissions comprising a front-mounted group, a main group, or as the case may be, a main gearbox, and a range group. In order to facilitate the complex shifting sequence resulting from the plurality of gears, most of these transmissions feature a shifting device automated by a gearbox actuator. Shifts in the front-mounted group and the range group can thereby be done pneumatically, while shifts in the main gearbox are performed manually by the vehicle driver or can be performed automatically by way of suitable electrohydraulic, electropneumatic, or electromotoric gear shifting devices, or by a combination of these actuators.

Motor vehicle transmissions of this type have several components that correspond to different functions, which are often integrated into the gearbox housing. Such components can, for example, be actuators, or as the case may be, gearbox actuators or sensors.

This results in the necessity for simple and cost-efficient assembly of these components, as well as the replaceabilty of individual components. In addition, superfluous interfaces should be avoided.

An automotive transmission is known from the applicant's DE 103 47 493 A1, with a housing, in which or on which torque-transmitting components are provided, which include a shifting device that is arranged between the vehicle transmission and a motor that drives the gearbox. In addition, actuating elements are arranged on the housing for actuating the torque-transmitting elements, whereby the housing comprises an area extending in the direction of the shifting device, in which an area connecting plate that can be permanently fixed to the housing is provided, in which accommodations are provided for at least some of the actuating elements for activating the torque-transmitting components. The actuating elements are preferably parts of a gearshift of a main gearbox or a splitting change-gear transmission and/or a range group transmission of the motor vehicle transmission.

In addition, from the applicant's DE 100 05 086 A1, a transmission with a central clutch disengaging device is known, whereby the device for disengaging the clutch is provided between the clutch disc and the clutch bell. In this case, the transmission control that is provided in or on the gearbox has a direct electronic connection to the clutch disengaging device; the medium for actuating the clutch is also derived directly from the clutch.

In addition, a device for measuring the transmission oil level is also known from the applicant's DE 199 15 471 A1, the device comprising a temperature sensor that is arranged outside the oil sump in the gearbox housing and is preferably directly integrated into the gearbox actuator.

In the constructions known from the state of the art, in which a separate component is provided on the gearbox housing, which contains the working cylinder of the actuating device and the corresponding integrated path sensors, additional components of the channel plate are provided: the valve plate, magnetic valves, a speed sensor, and a control unit. These components are affixed inside the cover of the gearbox actuator, said cover being mounted in a large compartment in the gearbox housing. Disadvantageously, this requires a special coupling with the shift rods. In addition, the automating components of the transmission actuator, which are the magnetic valves and the sensors, are integrated into the transmission actuator, which results in the necessity of an external wiring harness to the control unit (ECU) and a separate air supply.

The present invention is based on the objective of presenting a motor vehicle transmission, configured as a multi-group transmission, comprising a gearbox actuator, in which the cited disadvantages of the state of the art are avoided.

### SUMMARY OF THE INVENTION

Accordingly, a multi-group transmission is proposed, comprising a gearbox actuator, in which the working cylinder of the actuating devices of the gearbox actuator and the required air channels are integrated into the gearbox housing. Advantageously, it is proposed in accordance with the invention that the clutch actuator is also integrated into the gearbox housing.

In addition, it is also proposed, within the scope of the invention, that the gearbox actuator is constructed in a modular way, whereby the following modules are defined, which correspond to one assembly level in each case:

a sensor module;

a module consisting of the structural design and connection engineering and the control unit;

a magnetic-valve module, and a selection module containing the magnets.

According to an advantageous further development of the invention, the gearbox compartment for the electrical components is accessible from the outside by way of a cover and is separate from the oil chamber. Advantageously, it is also used as a collecting chamber for exhaust air.

By way of the conception of the invention, known components that are ready to go into production, along with reliable components, can be integrated into the gearbox, which results in fewer interfaces and thus in significant cost reduction. Only one electric and one pneumatic interface with the gearbox are required.

In addition, no separate, external wiring harness is needed on the gearbox, as the magnetic valves and the sensor of the clutch actuator are integrated into the magnetic-valve module, or as the case may be into the sensor module.

An additional advantage of the construction in accordance with the invention is that individual modules on the built-in gearbox can be replaced from the outside. Individual modules can also be tested separately.

### BRIEF DESCRIPTION OF THE DRAWING

The invention will now be described, by way of example, with reference to the accompanying drawing in which:

FIG. 1 is a perspective drawing of one part of a multi-group transmission of the invention.

### DETAILED DESCRIPTION OF THE INVENTION

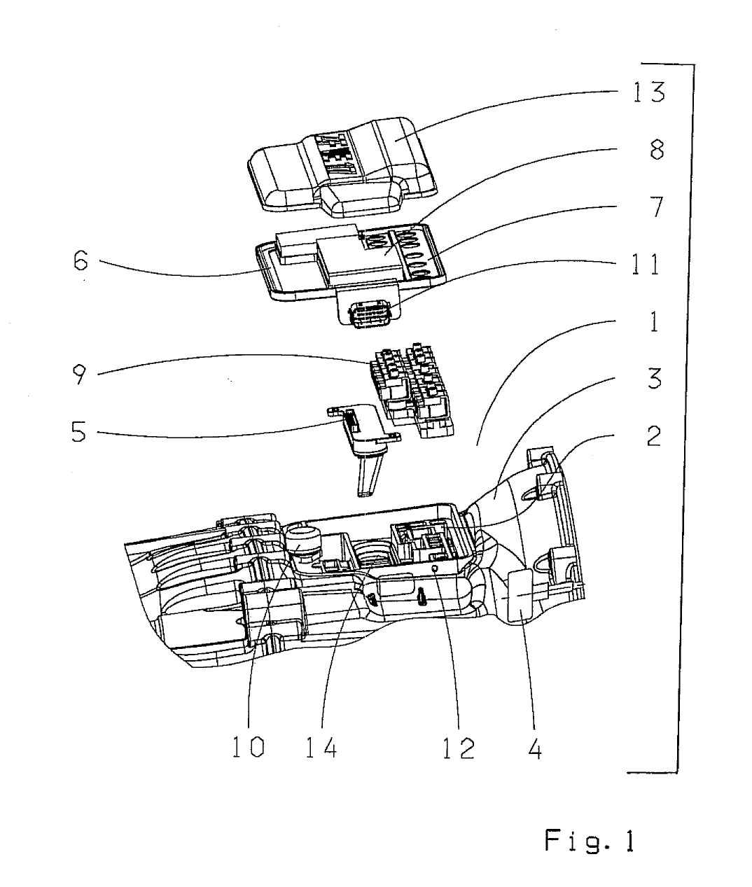

In FIG. 1, part of the gearbox 1 is shown. According to the invention, the working cylinder of the actuating device of the gearbox 1, the required air channels 2, and the clutch actuator 4 are integrated into the gearbox housing 3. The clutch actuator 4 is arranged centrally around the drive shaft.

As can be seen from FIG. 1, the gearbox actuator has a modular construction; the modules provided for are the sensor module 5, the module 6, which comprises construction and connection devices 7 and the control unit (ECU) 8, the magnetic valve module 9; and the selection module 10. In FIG. 1, the central plug connector, which is provided in module 6, is designated with 11, and the central pneumatic connection with 12.

The modules 5, 6, 9, and 10 are arranged in a gearbox compartment 14, which can be sealed by way of a cover 13. The electrical components are accessible from the outside through the cover 13, which enables simple replacement of individual components.

### REFERENCE NUMBERS

1 gearbox
2 air channel
3 gearbox housing
4 clutch actuator
5 sensor module
6 module containing the construction and connection devices and the control unit
7 construction and connection devices
8 control unit (ECU)
9 magnetic valve module
10 selection module
11 central plug connecter
12 central pneumatic connecter
13 cover
14 gearbox compartment

1-4. (canceled)

5. A multi-group transmission comprising:
a gearbox actuator,
a working cylinder of an activating device of the gearbox actuator, required air channels (2), and
a clutch actuator (4) being integrated into a gearbox housing (3).

6. The multi-group transmission according to claim 5, wherein the gearbox actuator has a modular construction which includes a sensor module (5), a magnetic-valve module (9), a selection module (10) and a module (6) that includes construction and connection devices (7) and a control unit (ECU) (8).

7. The multi-group transmission according to claim 6, wherein the sensor module (5), the magnetic-valve module (9), the selection module (10) and the module (6) that includes the construction and connection devices (7) and the control unit (ECU) (8), are arranged in a gearbox compartment (14) which is sealed by a cover (13).

8. The multi-group transmission according to claim 7, wherein the gearbox compartment (14) comprises a collection space for exhaust air.

9. A multi-group transmission comprising a transmission housing (3) with a compartment (14), an integral clutch controller (4) and integral air ducts (2), a removable cover (13) which encloses and seals, within the compartment (14), a sensor module (5), at least one connection device (7), an electronic control unit (8), a magnetic valve module (9), a selection module (10), a central plug connector (11) and a central pneumatic connection (12).
